(19) United States
(12) Patent Application Publication
(10) Pub. No.: US 2016/0069549 A1
(43) Pub. Date: Mar. 10, 2016

(54) ACCENT LIGHT ADAPTER MOUNT

(71) Applicant: Kendall J. Cox, (US)

(72) Inventor: Kendall J. Cox, Recluse, WY (US)

(21) Appl. No.: 14/483,076

(22) Filed: Sep. 10, 2014

(51) Int. Cl. F21V 21/116; F21S 9/03; F21S 6/00

(52) U.S. Cl. CPC F21V 21/116; F21S 6/007; F21S 9/03; F21W 2131/109

(57) ABSTRACT

An accent light adapter mount can receive accent lights (such as outdoor solar lights) and securely hold them in place without requiring the use of ground stakes. The accent light adapter mount can be attached to items such as railings, decks, fences, buildings, picnic tables, etc. and allows the normally limited-location, ground-stake accent lights to be used in many more locations. The accent light adapter mount has a containment plate, a mounting plate, a base plate, and a mounting cone. A mounting port in the containment plate receives the support column of a light and allows the column to be slid down over the mounting cone. Together, the two components hold the accent light in place in the adapter mount. Once the mount is attached to an item, the accent light is then held in place against the item without the use of a ground stake.

### TECHNICAL FIELD

The present invention relates generally to the field of accent lighting; and more specifically, to outdoor solar powered accent lights; and more specifically still, to an accent light adapter mount.

### BACKGROUND

There are a wide variety of outdoor accent lights available today. Many do not require any external wiring to operate as they utilize solar cells and light sensors instead. The solar cells charge up the lights during the day while the lights are off; and then when darkness falls, the light sensor switches on the accent light which is then powered by the stored solar energy.

Although there are a variety of accent lights available, many utilize a standard tubular support column that fits over a ground spike. The ground spike is designed to easily pierce the ground and then remain upright therein. An accent light support column can then be placed over the upright ground spike. The accent light is thereby held in the proper upright orientation and is ready to begin functioning. Although this installation system works well when an accent light is to be located on the ground, it fails miserably when a user wishes to place an accent light on a railing, deck, picnic table, wooden walkway, and other such locations where a ground spike can not simply be driven into the ground. Although there are other lighting solutions that can be employed in such instances, they often are expensive, fail to match with other ground-mounted accent lights already in use at a particular location, are not easily replaced or moved, and otherwise lack many of the benefits of standard ground-mounted access lights.

What is needed is an accent light adapter mount apparatus that can be mounted on railings, decks, picnic tables, walkways, sides of buildings, and other such locations where a ground spike can not be employed. Such an accent light adapter mount should easily receive and securely hold an accent light and yet allow for removal and replacement, as needed. Furthermore, an accent light adapter mount can have a decorative cover that conceals at least a portion of the tubular support column of an accent light and the internal components of an accent light adapter mount.

### SUMMARY

One embodiment of the present invention comprises a containment plate and a base plate, said plates held together and supported by a mounting plate. Together, the three plates form the main body of the accent light adapter mount. Extending through the containment plate is a mounting port in which the tubular support column of an accent light is inserted. The column is then pushed downwards over top of an accent light mounting cone that extends upwards from the base plate. The cone is sized so as to accommodate support columns having various diameters/sizes. The mounting plate can have a plurality of mounting holes which allow a user to screw, nail, or otherwise attach the accent light adapter mount to a surface. Additionally, an accent light adapter mount can have a decorative cover that removably attaches to the mount in order to enhance the visual appearance of the mount and/or help the mount to blend-in/match the look of its mounting location.

### BRIEF DESCRIPTION OF THE DRAWINGS

The aforementioned and other features and objects of the present invention and the manner of attaining them will become more apparent and the invention itself will be best understood by reference to the following descriptions of a preferred embodiment and other embodiments taken in conjunction with the accompanying drawings, wherein:

FIG. 1 illustrates a front perspective view of an exemplary embodiment of an accent light adapter mount;

FIG. 2 illustrates a front elevation view of an exemplary embodiment of an accent light adapter mount;

FIG. 3 illustrates a rear elevation view of an exemplary embodiment of an accent light adapter mount;

FIG. 4 illustrates a top plan view of an exemplary embodiment of an accent light adapter mount;

FIG. 5 illustrates a bottom plan view of an exemplary embodiment of an accent light adapter mount;

FIG. 6 illustrates a front perspective view of an exemplary embodiment of an accent light adapter mount with a decorative cover;

FIG. 7 illustrates a front perspective view of an exemplary embodiment of an accent light adapter mount with a decorative cover and holding an accent light; and

FIG. 8 illustrates a front perspective view of an exemplary embodiment of an accent light adapter mount holding an accent light and having corner plate supports.

### DETAILED DESCRIPTION

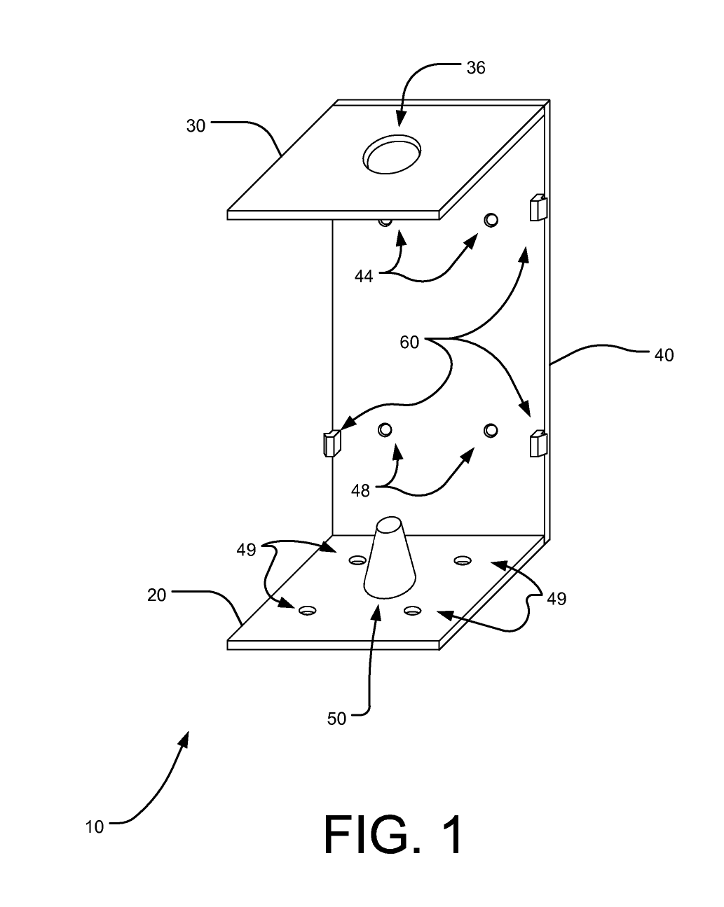

Referring now to the drawings, FIG. 1 illustrates a front perspective view of an exemplary embodiment of an accent light adapter mount 10. The primary components illustrated in FIG. 1 include a base plate 20, a containment plate 30, a mounting plate 40, a mounting port 36, and an accent light mounting cone 50. Additionally, an accent light adapter mount 10 can include a plurality of mounting holes 44, 48 and 49 that allow the adapter mount to be easily attached to various surfaces using screws, nails, or other types of attachments.

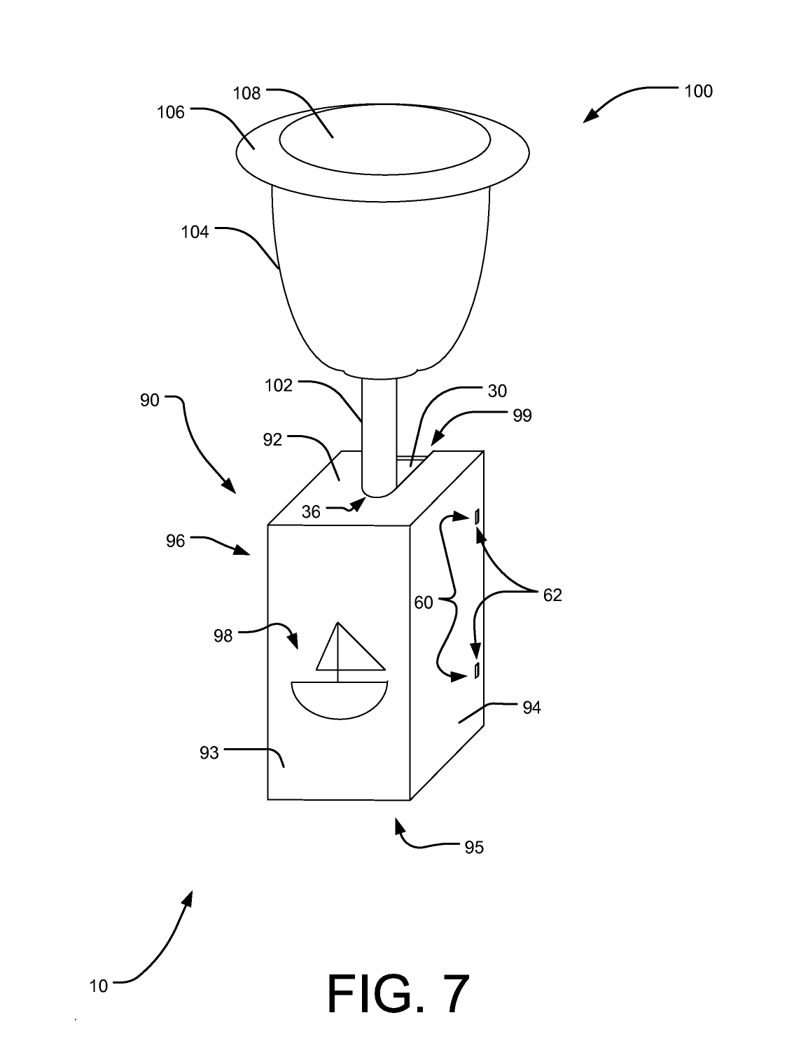

In one embodiment, the containment plate 30 has a mounting port 36 extending through the containment plate 30 and adapted to receive therethrough the tubular support column of an accent light (not shown in FIG. 1, see item 102 in FIG. 7). As many accent lights utilize support columns that resemble a cylinder (and so have a circular cross-section), the mounting port 36 can be shaped so as to match, and is therefore often a circle. However, in other embodiments, the mounting port 36 can be a triangle, square, rectangle, pentagon, oval, or any other useful shape that receives the accent light support column and holds it in place.

The containment plate 30 can be attached to a mounting plate 40. The mounting plate supports the containment plate 30 and holds it rigidly in place. Opposite the containment plate 30 is the base plate 20. It can be attached to the mounting plate 40 such that the mounting plate supports the base plate 20 and holds it rigidly in place. In another embodiment, the containment plate 30, the base plate 20, and the mounting plate 40 can be formed together as a single component (or two components) without departing from the scope of the invention. Together, the three plates 20, 30 and 40 form the main body of the accent light adapter mount.

The mounting plate 40 can have a plurality of mounting holes 44 and 48 extending therethrough (mounting holes 49 may also be included in this plurality, but they are located in the base plate 20 instead of the mounting plate 40). The mounting holes 44 and 48 can be used to attach the accent light adapter mount to a surface, for example, a deck railing. The user can deploy nails, screws, or other attachments through the plurality of mounting holes 44 and 48 to secure the accent light adapter mount. Although FIG. 1 illustrates an embodiment having four mounting holes 44 and 48 in the mounting plate 40, the location and number of the plurality of mounting holes can vary. For example, additional mounting holes 49 can be located in the base plate 20.

Extending generally upwards from the base plate 20 is a mounting cone 50. In the embodiment shown in FIG. 1, the mounting cone 50 appears as a conical shape with a truncated tip (where the base of the cone is larger than the tip or top of the cone). In another embodiment, the tip is not truncated. In yet other embodiments, the cone employs a plurality of graduated steps such as a stepped pyramid. Additionally, instead of employing a full cone 50, some embodiments may use a cone section (forming a “−” minus sign when viewed from above), or two cone sections (together forming a “+” plus sign when viewed from above). Regardless, the mounting cone 50 can be sized so as to accommodate support columns having various diameters and/or sizes. For example, the outside diameter of the mounting cone 50 at the point at which it attaches to the base plate 20 may be three quarters of an inch (0.75″) and the top may truncate at a diameter of one tenth of an inch (0.10″). In other embodiments, smaller and larger mounting cones are contemplated. All of the mounting cone embodiments described above constitute cones and cone-shapes. A mounting cone 50 can be made from any of a number of different materials. For example, a rubber-like material may be used in one embodiment. In another embodiment, the mounting cone 50 can be plastic. In yet another embodiment, metal can be used as the material of choice.

Although the vast majority of accent light tubular support columns have a circular cross-section, it is contemplated that some may have square, triangular, or other shapes. Therefore, the mounting cone 50 may be a three-sided pyramid to match a triangular support column, or a four-sided pyramid to match a square support column. Similarly, other shapes may be needed to match support columns that utilize other shapes. It is contemplated that the mounting cone 50 can be removed and replaced with other shapes/sizes to accommodate as many accent lights as possible.

Regardless of the shape of the mounting cone 50, it functions as a mount upon which a support column for an accent light is placed. Such support columns are hollow and so fit directly over the mounting cone 50. The column can then be pushed downwards, tightly fitting over the mounting cone and held in place by a friction fit (a slight deformation of one or both of the column and the cone so that they grip one another and are thus removably locked together).

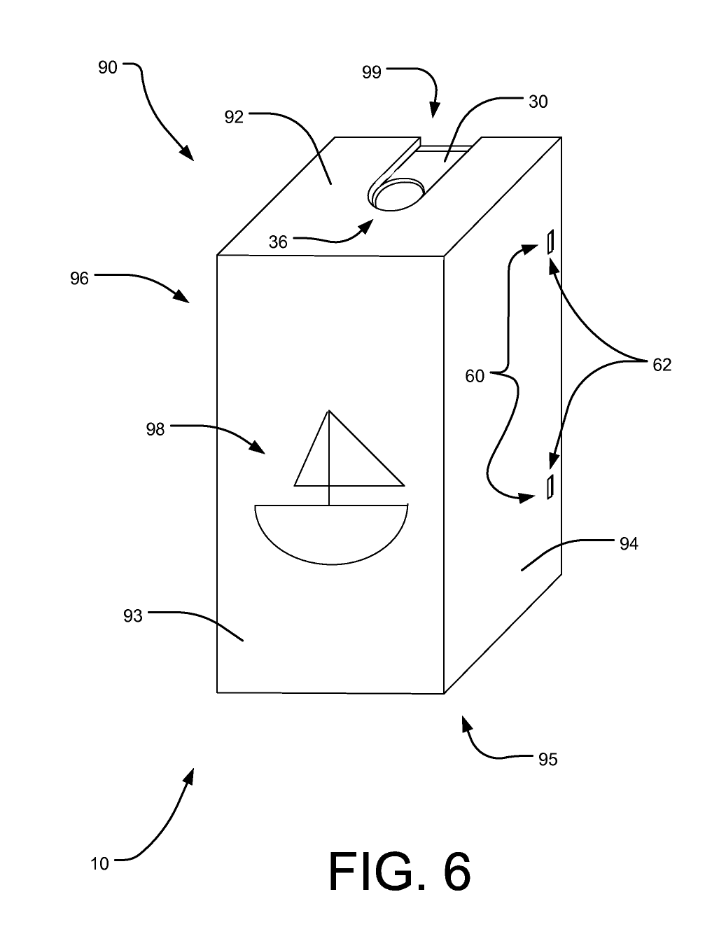

An accent light adapter mount 10 can have a decorative cover that removably attaches to the mount in order to enhance the visual appearance of the mount and/or help the mount to blend-in/match the look of its mounting location. Although such a decorative cover is not shown in FIG. 1, an exemplary decorative cover 90 is illustrated in FIGS. 6 and 7. FIG. 1 does include a plurality of cover snap clips 60 that are adapted to removably attach a decorative cover to the main body of the accent light adapter mount. Although FIG. 1 shows these snap clips 60 as being attached to the mounting plate 40, they could be additionally or alternatively located on the containment plate 30 and/or the base plate 20.

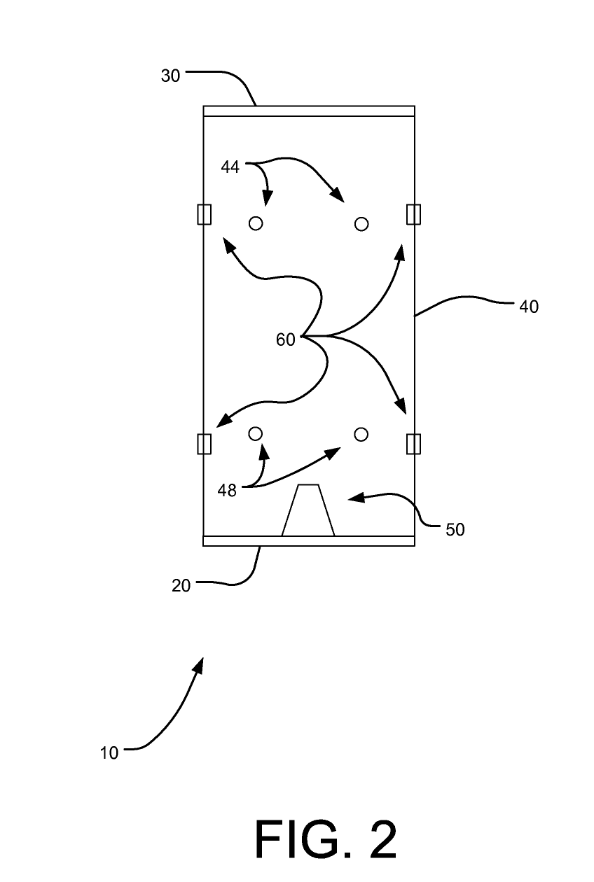

FIG. 2 illustrates a front elevation view of an exemplary embodiment of an accent light adapter mount 10. Since the containment plate 30 and the base plate 20 are oriented horizontally here, the majority of this view is displaying the mounting plate 40. Additionally, in the embodiment illustrated in FIG. 2, four of the plurality of decorative cover snap clips 60 are shown, in other embodiments, the number of snap clips may be smaller or larger. The illustrated snap clips 60 are designed to bow inwards as the cover is slid over them and then they snap back outwards into snap slots on the decorative cover, locking it in place. In other embodiments, other types of snap clips 60 can be utilized to hold the cover in place. In yet other embodiments, screw(s), pin(s), or other attachment devices are contemplated.

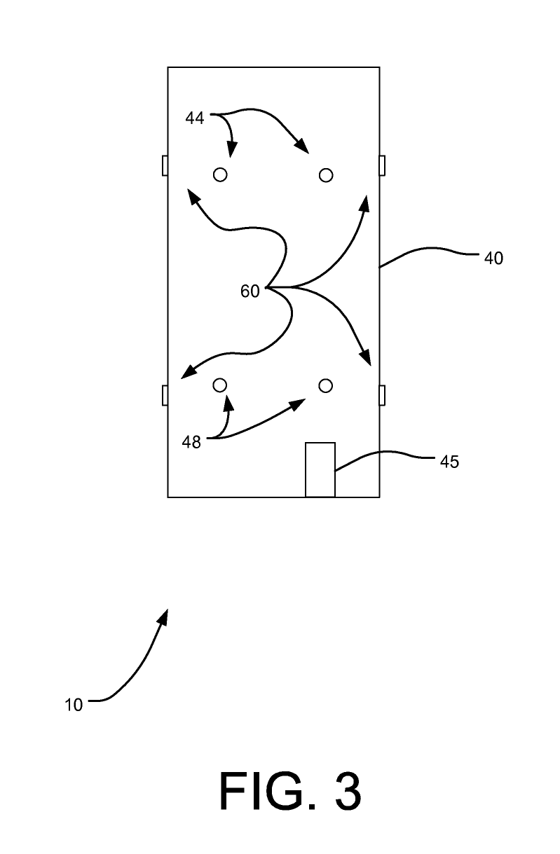

FIG. 3 illustrates a rear elevation view of an exemplary embodiment of an accent light adapter mount 10. Note the inclusion of a wiring port 45 in the embodiment illustrated in FIG. 3. This port serves as an access point into the interior of the accent light adapter mount 10 and can be used for any number of functions. For example, if a user would like to provide a permanent source of external power (such as low-voltage wiring, AC wiring, etc.), electrical wires could be strung through the wiring port 45 and connected to the accent light inside the adapter mount 10. As another example, an override remote switch could be wired through the wiring port 45 to allow a user to turn the lights on or off regardless of the setting provided by the automated sensors on the accent lights.

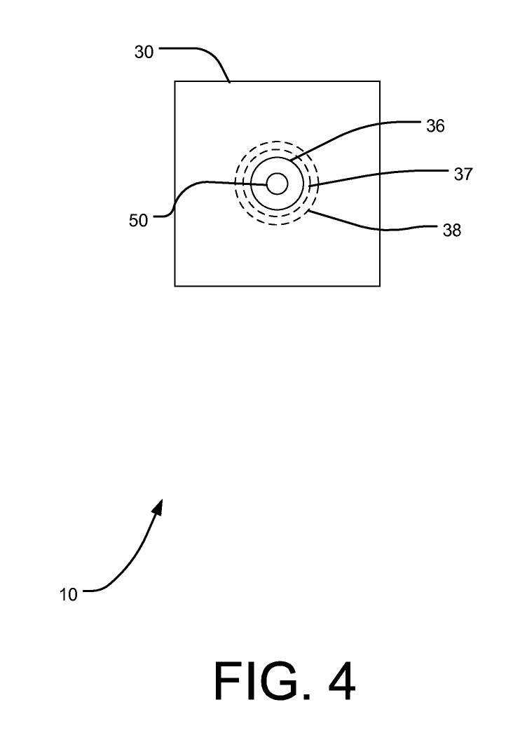

FIG. 4 illustrates a top plan view of an exemplary embodiment of an accent light adapter mount 10. In this view, the top of the containment plate 30 can be seen. The mounting port 36 is visible as is the top of the mounting cone 50 (which is viewable through the mounting port 36). Also illustrated in the embodiment of FIG. 4 is a plurality of pop-out resize rings 37 and 38. The pop-out resize rings 37 and 38 are illustrated as larger diameter, broken line mounting ports. The broken lines represent pre-cut portions of the containment plate 30 such that if the user desires a larger mounting port 36, he or she can simply pop-out one of the larger pop-out resize rings 37 or 38. In an alternate embodiment, the plurality of pop-out resize rings 37 and 38 can number greater than or less than two. Similarly, the resize rings can utilize larger cut-out portions, having even as few as two non-cut portions holding the rings in place.

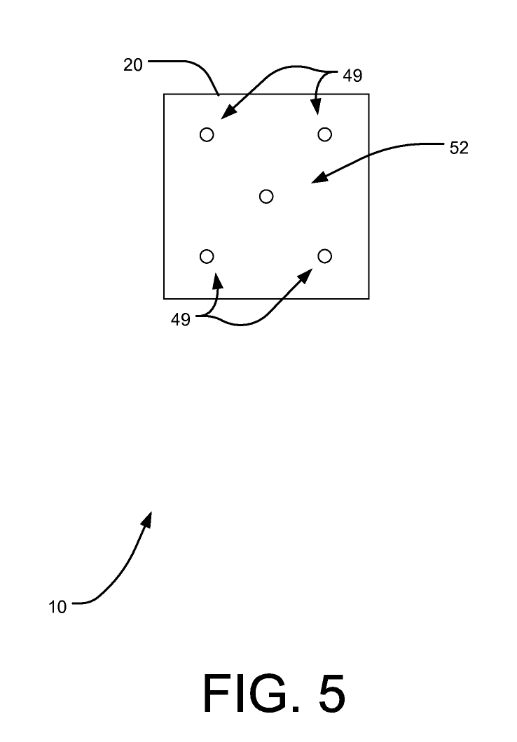

FIG. 5 illustrates a bottom plan view of an exemplary embodiment of an accent light adapter mount 10. The base plate 20 is visible from below as is the mounting cone connector 52. In this embodiment, the mounting cone connector 52 is a simple rivet that attaches the mounting cone 50 to the base plate 20. In other embodiments, other means of attaching the mounting cone 50 to the base plate 20 are contemplated. In yet another embodiment, the mounting cone 50 is built integrally into the base plate 20 (for example, they could comprise a single component formed in a plastic mold). Also shown in FIG. 5 is a plurality of mounting holes 49.

FIG. 6 illustrates a front perspective view of an exemplary embodiment of an accent light adapter mount 10 with a decorative cover 90. The decorative cover 90 is adapted to fit over the adapter mount 10 and lock in place thereon. The decorative cover 90 illustrated in FIG. 6 has a top face 92, a front face 93, a right face 94, a bottom face 95, and a left face 96. The top face 92 fits over the containment plate 30. Similarly, the bottom face 95 fits over the base plate 20. The decorative cover 90 can therefore add support and strength to the main body of the accent light adapter mount 10 by holding the plates 20, 30, and 40 in place relative to one another.

The top face 92 of the decorative cover 90 can incorporate a tubular support column slot 99. The support column slot 99 allows the cover 90 to be applied and removed with the accent light secured within the accent light adapter mount 10. Without the slot 99, the accent light would need to be removed before the cover 90 could be opened or closed.

As the cover 90 is slid onto the main body, the plurality of cover snap clips 60 are first bowed inwards and then are allowed to snap back into place as they enter the snap slots 62. The snap clips 60 then engage the snap slots 62 and hold the decorative cover 90 in place. To remove the cover 90, a user simply presses the snap clips 60 inwards, bowing them so that they disengage from the snap slots 62, and the cover 90 can then be slid off of the main body.

Also illustrated on the decorative cover 90 shown in FIG. 6 is an ornamentation 98. The ornamentation 98 illustrated is that of a sailboat. In other embodiments, other ornamentations 98 are contemplated. Similarly, the decorative covers 90 can be colored, covered with patterns, customized by users, etc.

FIG. 7 illustrates a front perspective view of an exemplary embodiment of an accent light adapter mount 10 with a decorative cover 90 and holding an accent light 100. The tubular support column 102 of the accent light 100 is shown in place extending upwards through the mounting port 36. The accent light 104 is illustrated in position above the support column 102. Atop the accent light 104 is a protective cap 106 and a solar cell 108 that powers the accent light 104.

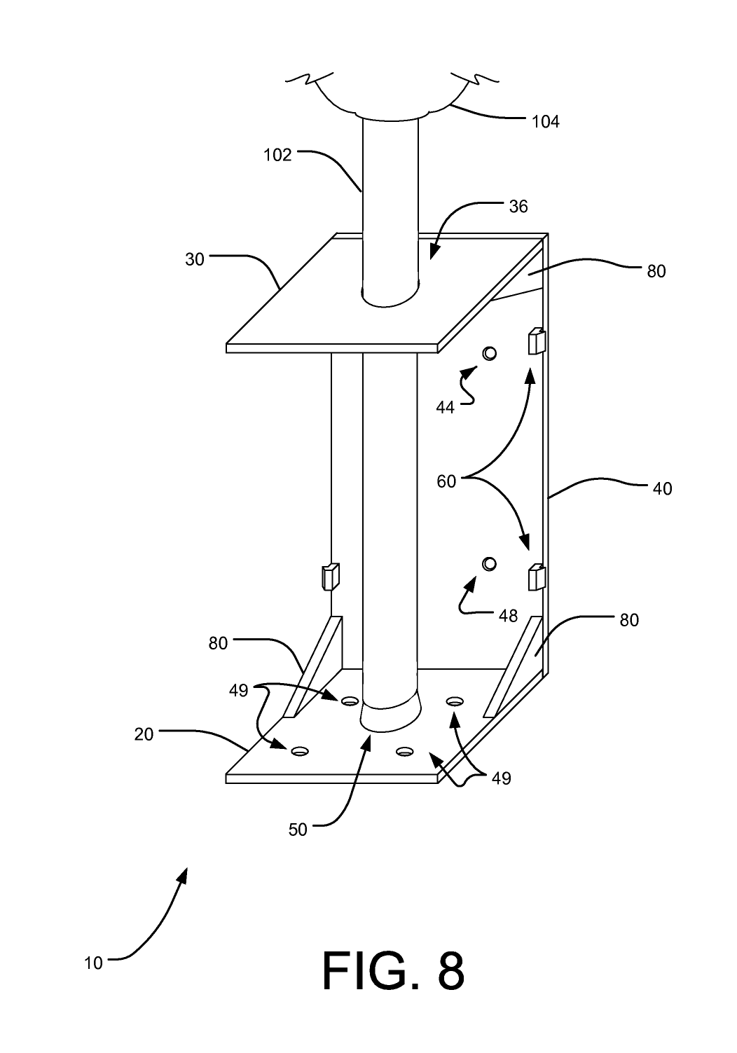

FIG. 8 illustrates a front perspective view of an exemplary embodiment of an accent light adapter mount 10 holding an accent light and having a plurality of corner plate supports 80. This embodiment is illustrated with the decorative cover removed so that the engagement of the bottom of the accent light's tubular support column 102 with the mounting cone 50 can be more clearly seen. Since the mounting cone increases in size from the top of the cone to the point where it is attached to the base plate 20, the hollow end of the support column 102 fits over the cone and can be pressed downwards. When the interior of the support column 102 engages the exterior of the mounting cone 50, the cone and/or the support column slightly deform and hold fast to one another.

A plurality of corner plate supports 80 are illustrated in the embodiment of FIG. 8. The corner plate supports 80 each function to strengthen the attachment between the plates. For example, the upper right corner plate support 80 shown just above mounting hole 44 functions to strengthen the attachment between the containment plate 30 and the mounting plate 40.

As can be seen in the illustration of FIG. 8, the accent light can be quickly and easily installed into and remove from the accent light adapter mount 10 simply by inserting the accent light's tubular support column 102 into the mounting port 36 and pressing it onto the mounting cone 50. The containment plate 30 then holds the light in place on the upper end of the support column 102 and the firm connection at the mounting cone 50 holds the lower end. However, by simply twisting and pulling the support column 102 upwards, the column releases the mounting cone 50 and easily slides out of the accent light adapter mount 10. In order to increase the weather resistance of the mount 10, rubber seals, weather-stripping, and/or other types of seals, caulk, etc. may be used.

While particular embodiments of the invention have been described and disclosed in the present application, it should be understood that any number of permutations, modifications, or embodiments may be made without departing from the spirit and scope of this invention. Accordingly, it is not the intention of this application to limit this invention in any way except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above “Detailed Description” section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise embodiment or form disclosed herein or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

In light of the above “Detailed Description,” the Inventor may make changes to the invention. While the detailed description outlines possible embodiments of the invention and discloses the best mode contemplated, no matter how detailed the above appears in text, the invention may be practiced in a myriad of ways. Thus, implementation details may vary considerably while still being encompassed by the spirit of the invention as disclosed by the inventor. As discussed herein, specific terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

The above specification, examples and data provide a description of the structure and use of exemplary implementations of the described articles of manufacture and methods. It is important to note that many implementations can be made without departing from the spirit and scope of the invention.

What is claimed is:

1. An accent light adapter mount, comprising:
a mounting plate having an upper end and a lower end and extending longitudinally therebetween, the upper end attached to a containment plate and the lower end attached to a base plate;
the containment plate having a mounting port extending therethrough;
the mounting port adapted to receive therein a support column for an accent light;
the base plate having an accent light mounting cone extending upwards therefrom;
the accent light mounting cone adapted to removably engage and securely hold a support column bottom portion that can be pressed down onto the accent light mounting cone and is then held in place via a friction fit with the accent light mounting cone;
a plurality of mounting holes adapted to allow the accent light adapter mount to removably attach to a surface;
a main body comprising at least the containment plate, the mounting plate, and the base plate;
the mounting cone having a cone top and a cone base and wherein the cone top is smaller than the cone base; and
wherein at least one of the plurality of mounting holes is located on the main body.

2. The accent light adapter mount of claim 1, wherein the mounting cone is a three-sided pyramid.

3. The accent light adapter mount of claim 1, wherein the mounting cone is a four sided pyramid.

4. The accent light adapter mount of claim 1, further comprising:
a decorative cover that removably attaches to the main body; and
a plurality of cover snap clips that are adapted to removably attach a decorative cover to the main body of the accent light adapter mount.

5. The accent light adapter mount of claim 2, further comprising:
a decorative cover that removably attaches to the main body; and
a plurality of cover snap clips that are adapted to removably attach a decorative cover to the main body of the accent light adapter mount.

6. The accent light adapter mount of claim 3, further comprising:
a decorative cover that removably attaches to the main body; and
a plurality of cover snap clips that are adapted to removably attach a decorative cover to the main body of the accent light adapter mount.

7. The accent light adapter mount of claim 1, further comprising:
a first plurality of corner plate supports attached to the base plate and the mounting plate and adapted to strengthen an attachment between the base plate and the mounting plate.

8. The accent light adapter mount of claim 7, further comprising:
a second plurality of corner plate supports attached to the base plate and the containment plate and adapted to strengthen an attachment between the base plate and the containment plate.

9. The accent light adapter mount of claim 4, further comprising:
a first plurality of corner plate supports attached to the base plate and the mounting plate and adapted to strengthen an attachment between the base plate and the mounting plate.

10. The accent light adapter mount of claim 9, further comprising:
a second plurality of corner plate supports attached to the base plate and the containment plate and adapted to strengthen an attachment between the base plate and the containment plate.

11. The accent light adapter mount of claim 5, further comprising:
a first plurality of corner plate supports attached to the base plate and the mounting plate and adapted to strengthen an attachment between the base plate and the mounting plate.

12. The accent light adapter mount of claim 11, further comprising:
a second plurality of corner plate supports attached to the base plate and the containment plate and adapted to strengthen an attachment between the base plate and the containment plate.

13. The accent light adapter mount of claim 6, further comprising:
a first plurality of corner plate supports attached to the base plate and the mounting plate and adapted to strengthen an attachment between the base plate and the mounting plate.

14. The accent light adapter mount of claim 13, further comprising:
a second plurality of corner plate supports attached to the base plate and the containment plate and adapted to strengthen an attachment between the base plate and the containment plate.

15. An accent light adapter mount, comprising:
a mounting plate having an upper end and a lower end and extending longitudinally therebetween, the upper end attached to a containment plate and the lower end attached to a base plate;
a plurality of corner plate supports attached to the base plate and another plate and adapted to strengthen an attachment between the base plate and the other plate;
the containment plate having a mounting port extending therethrough;
the mounting port adapted to receive therein a support column for an accent light;
the base plate having an accent light mounting cone extending upwards therefrom;
the accent light mounting cone adapted to removably engage and securely hold a support column bottom portion that can be pressed down onto the accent light mounting cone and held in place via a friction fit with the accent light mounting cone;
a plurality of mounting holes adapted to allow the accent light adapter mount to removably attach to a surface;
a main body comprising at least the containment plate, the mounting plate, and the base plate;
the mounting cone having a cone top and a cone base and wherein the cone top is smaller than the cone base; and
wherein at least one of the plurality of mounting holes is located on the main body.

16. The accent light adapter mount of claim 15, wherein the mounting cone is a three-sided pyramid.

17. The accent light adapter mount of claim 15, wherein the mounting cone is a four sided pyramid.

18. The accent light adapter mount of claim 15, further comprising:
a decorative cover that removably attaches to the main body; and
a plurality of cover snap clips that are adapted to removably attach a decorative cover to the main body of the accent light adapter mount.

19. The accent light adapter mount of claim 16, further comprising:
a decorative cover that removably attaches to the main body; and
a plurality of cover snap clips that are adapted to removably attach a decorative cover to the main body of the accent light adapter mount.

20. The accent light adapter mount of claim 17, further comprising:
a decorative cover that removably attaches to the main body; and
a plurality of cover snap clips that are adapted to removably attach a decorative cover to the main body of the accent light adapter mount.
